(19) United States
(12) Patent Application Publication
(10) Pub. No.: US 2023/0399489 A1
(43) Pub. Date: Dec. 14, 2023

(54) HEAT STABILIZER FOR POLYMER PROCESSING USING PHOSPHATE WITH SUPPRESSED CRYSTALLINITY, AND METHOD FOR PREPARING THE SAME

(71) Applicant: INDUSTRY ACADEMIC COOPERATION FOUNDATION OF YEUNGNAM UNIVERSITY, Gyeongsan-si, Gyeongsangbuk-do (KR)

(72) Inventors: Seong Cheol KIM, Gyeongsan-si, Gyeongsangbuk-do (KR); Periyasamy THIRUKUMARAN, Gyeongsan-si, Gyeongsangbuk-do (KR)

(21) Appl. No.: 18/248,763

(22) PCT Filed: Oct. 13, 2021
(86) PCT No.: PCT/KR2021/013965

§ 371 Date: Apr. 12, 2023

(30) Foreign Application Priority Data
Oct. 22, 2020 (KR) 10-2020-0137653
Oct. 12, 2021 (KR) 10-2021-0134725

(51) Int. Cl. C08K 3/32; C01B 25/40

(52) U.S. Cl. CPC C08K 3/32; C01B 25/40; C01P 2002/50; C01P 2004/64; C01P 2004/62; C08K 2003/325; C08K 2003/328

(57) ABSTRACT

Proposed is a heat stabilizer for polymer processing, the heat stabilizer being represented by A_{w}(PO₄)ₓ(HPO₄)_{y}X_{z}·nH₂O, having excellent thermal stability capable of preventing discoloration of a polymer when processing a polymer such as PVC, and being applicable to various polymers aside from PVC. In addition, the present disclosure provides an effective method of preparing a heat stabilizer preventing discoloration when processing a polymer by the following method: lowering the crystallinity of a metal phosphate by replacing with various metal cations, changing the type and content of anion, and using various dispersants serving as ligands; or reducing the particle size by adjusting the pH using a strong base and by performing a rapid synthesis process.

### TECHNICAL FIELD

The present disclosure relates to a polymer processing heat stabilizer using a phosphate having suppressed crystallinity and to a method of preparing the same. More particularly, the present disclosure relates to a polymer processing heat stabilizer using a crystallinity-controlled phosphate, thereby having improved dispersibility and being capable of preventing discoloration of a polymer, to a preparation method of the heat stabilizer, and a polymer composition including the heat stabilizer.

### BACKGROUND ART

Organic lead (Pb) was widely used as a heat stabilizer for PVC, and organic Cd then replaced the organic lead due to toxicity. Recently, low-toxic or non-toxic products such as Ba, Ca, Zn, and Sn have been mainly used.

However, the recent products have a problem in that the thermal stability thereof is significantly lower than that of lead stabilizers that were used in the past. To overcome the problem, there has been an approach where a metal salt or a mixture of two or more metal salts were added in a large amount.

In addition, epoxidized soybean oil and organophosphite have been used as auxiliary additives to more enhance thermal stability. Aside from the materials described above, lanthanum compounds and organic amides such as uracil have been reported as excellent heat stabilizers.

As a conventional art for improving the thermal stability of PVC, Korean Patent No. 10-1426604 discloses a technique in which hydrotalcite is added to PVC to improve the thermal stability. Hydrotalcite is a layered compound and provides an eco-friendly heat stabilizer that improves heat resistance and thermal stability of PVC by performing anion exchange using an interlayer insert added thereto. A reactive interlayer insert is inserted between the layers of the hydrotalcite to improve thermal stability and colorability of PVC. In this case, there is a problem in that since the pH condition changes over time, the long-term storage property of the interlayer insert is not good.

On the other hand, Korean Patent No. 10-2049484 discloses a heat stabilizer composition for polyvinyl chloride (PVC), the composition comprising: niobate nanosheets containing zinc oxide and magnesium oxide; and a hydroxide mixture consisting of calcium hydroxide and aluminum hydroxide, thereby exhibiting good thermal stability, processing stability, and long-term storage stability required for PVC heat stabilizers.

### DISCLOSURE

### Technical Problem

An objective of the present disclosure is to provide a heat stabilizer for polymer processing, the heat stabilizer having low crystallinity achieved through various structural changes of metal phosphate compounds composed of various metal cations and phosphate anions, and having an increased surface area due to a reduced particle size, whereby in the heat stabilizer, the phosphate can absorb an increased amount of HCl, which contributes improvement in thermal stability.

Another objective of the present disclosure is to provide a method of preparing a polymer processing heat stabilizer capable of improving thermal stability, using various methods.

A further objective of the present disclosure is to provide a polymer composition including a polymer and the heat stabilizer described above to prevent the polymer from being discolored.

### Technical Solution

To achieve one of the objectives of the present disclosure, there is provided a heat stabilizer for polymer processing, the heat stabilizer being represented by the following chemical formula:

A_{w}(PO₄)ₓ(HPO₄)_{y}X_{z}·nH₂O

in the chemical formula, A is at least one type of polyvalent cation selected from the group Ca, Mg, Al, Fe, Ti, Sn, Ba, Zn, Cu, Cd, Pb, Mn, Ni, Sr, and Mo; w is within the range of 2 to 5;

X is at least one type of anion selected from the group consisting of Cl⁻, Br⁻, NO₃⁻, OH⁻, acetate, cyanide, thiocyanate, isocyanate, hydrogensulfate, dihydrogen phosphate, phosphite, polyphosphate, carbonate, sulfonate, borate, carbonate, sulfate, carboxylate, adipate, dodecylsulfate, nitrate, and P₂O₇⁴⁻; z is within the range of 0 to 3;

x and y are each independently a number within the range of 0 to 5, there is no case that both of x and y are 0 at the same time, and either one of x and y is not 0;

in the chemical formula, w, x, y, and z satisfy an expression of 2w=3x+2y+1z when X is a monovalent anion but satisfy an expression of 2w=3x+2y+0.5z is satisfied when X is a divalent anion; and

n is an integer in the range of 0 to 12.

According to one embodiment of the present disclosure, the polyvalent cation represented by A in the chemical formula may be a single type of metal cation among the various types of metal cations listed above, or a form in which 50 mol % or more of one type of metal cation including Ca is replaced with one or more types of other metal cations.

In addition, according to one embodiment of the present disclosure, X may be a mixture of anions in which OH⁻, which is a type of anion, is

replaced with one or more types of anions, in a molar ratio of 0.1 to 100 mol %, selected from the group consisting of Cl⁻, Br⁻, NO₃⁻, acetate, cyanide, thiocyanate, isocyanate, hydrogensulfate, dihydrogen phosphate, phosphite, polyphosphate, carboxylate, carbonate, sulfonate, borate, carbonate, sulfate, carboxylate, adipate, dodecyl sulfate, nitrate, and P₂O₇⁴⁻.

In addition, the polymer processing heat stabilizer represented by the above chemical formula preferably has a particle size in the range of 0.5 to 150 nm.

Additionally, the polymer processing heat stabilizer according to the present disclosure may further include one or more types of dispersants acting as ligands for the polyvalent cation A of the above chemical formula, the one or more types of dispersants being selected from: one or more diesters selected from the group consisting of amines, amides, phosphonates, carboxylic acids, thioesters, alkanoates, diketones, ketoesters, oxalates, malonates, succinates, glutarates, and adipates;
ketoacids having one carboxylic acid and one ester group;
lactones including maleic anhydride, succinic anhydride, and lactide;
lactams including caprolactam;
a chelating agent including a polyvalent acid or a salt thereof;
vinyl ester derivatives including vinyl acetate;
poly(ethylenimine) and derivatives thereof;
(meth)acrylates and derivatives thereof;
cellulose derivatives; and
cellulose acetate derivatives.

According to one embodiment of the present disclosure, the polyvalent cation A and the ligand included in the dispersant may be included in a ratio of 1:0.5 to 1:6.

In addition, the present disclosure provides a method of preparing the metal phosphate polymer processing heat stabilizer according to claim 1, the method including a step of preparing a metal phosphate by rapidly reacting an aqueous metal salt solution and a phosphoric acid (salt) containing a metal cation at a pH of 10 to 13 for 10 to 120 minutes so that the metal phosphate to be prepared has a reduced particle size in the range of 0.5 to 150 nm to improve thermal stability.

In addition, the present disclosure provides a method of preparing a metal phosphate polymer processing heat stabilizer, the method including a step of ion-exchanging a portion of OH⁻ anion represented by X in the above chemical formula with one or more types of anions selected from the group consisting of Cl⁻, Br⁻, NO₃⁻, acetate, cyanide, thiocyanate, isocyanate, hydrogensulfate, dihydrogen phosphate, phosphite, polyphosphate, carbonate, sulfonate, borate, carbonate, sulfate, carboxylate, adipate, dodecylsulfate, nitrate, and P₂O₇⁴⁻ in a ratio of 0.1 to 100 mol %, thereby lowering the crystallinity of the metal phosphate to improve thermal stability.

In addition, the present invention provides a metal phosphate polymer processing heat stabilizer preparation method capable of improving thermal stability of a polymer by including a step of adding one or more types of dispersants serving as ligands for the polyvalent cation A in the above chemical formula to play one or more roles among the following roles:
a) providing electron pairs by means of ionic bonds, coordinate covalent bonds, or strong ion-dipole interactions with metal cations;
b) increasing an ionic distance between the metal cation A and the anion X to reduce an ionic binding force; or
c) increasing a particle surface area by suppressing crystal formation of the metal phosphate to reduce a particle size,

the one or more types of dispersants being selected from:
one or more diesters selected from the group consisting of amines, amides, phosphonates, carboxylic acids, thioesters, alkanoates, diketones, ketoesters, oxalates, malonates, succinates, glutarates, and adipates;
   ketoacids having one carboxylic acid and one ester group;
   lactones including maleic anhydride, succinic anhydride, and lactide;
   lactams including caprolactam;
   a chelating agent including a polyvalent acid or a salt thereof;
   vinyl ester derivatives including vinyl acetate;
   poly(ethylenimine) and derivatives thereof;
   (meth)acrylates and derivatives thereof;
   cellulose derivatives; and
   cellulose acetate derivatives.

In addition, the present disclosure provides a polymer composition including the polymer processing heat stabilizer represented by the above chemical formula and one or more types of polymers selected from the group consisting of PVC, PMMA, PS, PB, PC, PE, PP, ABS, natural rubber, and synthetic rubber.

The polymer processing heat stabilizer is preferably included in an amount of 1 to 5 parts by weight based on the weight of the polymer.

### Advantageous Effects

The heat stabilizer according to the present disclosure has excellent thermal stability capable of preventing discoloration of polymers during processing of the polymers such as PVC, and is expected to be applicable to various polymers as well as PVC.

In addition, in the present disclosure, the crystallinity of metal phosphates is lowered in a diversity of manners such as replacing metal cations in the conventional metal phosphates, changing the type or content of anions, or using a variety of dispersants that can act as ligands. Alternatively, the particle size of metal phosphates is reduced by pH adjustment and rapid synthesis using a strong base, to increase a larger surface area which enables most of the phosphate to absorb HCl and inhibits the acceleration of discoloration that occurs due to HCl. That is, the present disclosure provides a method of effectively preparing a heat stabilizer preventing discoloration of a polymer during processing of the polymer in the way described above.

### DESCRIPTION OF DRAWINGS

The patent or application file contains at least one drawing executed in color. Copies of this patent or patent application publication with color drawing(s) will be provided by the Office upon request and payment of the necessary fee.

FIG. 1 shows the results of comparison in thermal stability characteristics according to particle size of Ca₅(PO₄)₃ and hydroxyapatite in Example 1;

FIG. 2 shows the results of comparison in thermal stability characteristics according to the relative ratio of metal ions and phosphorus in Example 2;

FIG. 3 shows the results of analysis of thermal stability characteristics according to the ratio of calcium ions to other metal ions in Example 3;

FIG. 4 shows changes in thermal stability characteristics according to the types of anion X in Ca₄Ba₁(PO₄)₃X compounds;

FIG. 5 shows the results of comparison in thermal stability characteristics of metal phosphate, M₅(PO₄)₃OH (M=Ca:Ba:Zn=8:1:1), according to the types of dispersant;

FIG. 6 shows the results of comparison in thermal stability characteristics of hydroxyapatite (HA) according to the types of dispersant;

FIG. 7 shows the results of comparison in film discoloration over time among the cases where Ca_{4.5}Ba_{0.5}(PO₄)₂(HPO₄)_{1.5} stearate, Ca/Zn-stearate, Sn-stearate, Ba-stearate, and Sn-octoate are used, respectively, at a concentration of 1 phr; and

FIG. 8 shows the results of comparison in film discoloration over time among Zn₅(PO₄)₃ among the cases where Zn₅(PO₄)₃·stearate, Ca/Zn-stearate, Pb-stearate, Ba-stearate, and Sn-octoate are used, respectively, at a concentration of 3 phr.

### BEST MODE

Hereinafter, the present disclosure will be described in detail.

The terminology used herein is for describing specific embodiments and is not intended to limit the present disclosure.

As used herein, the singular forms “a,” “an,” and “the” may include plural forms, unless the context clearly dictates otherwise. In addition, as used herein, “comprise” and/or “comprising” specify the presence of shapes, numbers, steps, operations, members, elements, and/or combinations thereof, and do not preclude the presence or addition of one or more other shapes, numbers, operations, elements, and/or combinations thereof.

The present disclosure relates to a polymer processing heat stabilizer using a crystallinity-controlled phosphate and to a method of preparing same.

The polymer processing heat stabilizer using a phosphate, according to the present disclosure, is characterized in that it is represented by the following formula:

A_{w}(PO₄)ₓ(HPO₄)_{y}X_{z}·nH₂O
In the formula, A is at least one type of polyvalent cation selected from the group Ca, Mg, Al, Fe, Ti, Sn, Ba, Zn, Cu, Cd, Pb, Mn, Ni, Sr, and Mo; w is within the range of 2 to 5;

X is at least one type of anion selected from the group consisting of Cl⁻, Br⁻, NO₃⁻, OH⁻, acetate, cyanide, thiocyanate, isocyanate, hydrogensulfate, dihydrogen phosphate, phosphite, polyphosphate, carbonate, sulfonate, borate, carbonate, sulfate, carboxylate, adipate, dodecylsulfate, nitrate, and P₂O₇⁴⁻; z is within the range of 0 to 3;

x and y are each independently a number within the range of 0 to 5, there is no case that both of x and y are 0, and either one of x and y is not 0;

in the formula, w, x, y, and z satisfy an expression of 2w=3x+2y+1z when X is a monovalent anion but satisfy an expression of 2w=3x+2y+0.5z is satisfied when X is a divalent anion; and

n is an integer in the range of 0 to 12.

Conventionally, when A is a metal phosphate compound such as calcium hydrogen phosphate (Ca(H₂PO₄)₂) or calcium phosphate (hydroxyapatite, Ca₅(PO₄)₃), which is composed of a divalent or higher cation and a phosphate anion, the electrostatic attraction between the two ions is so great that the metal phosphate compound easily crystallizes. When the crystals are formed, the particle size is at least several tens of nanometers or more. The crystal of the described size includes at least hundreds of molecules of the compound therein, but only 10% or less of phosphoric acid is present on the surface thereof. Although each ion can serve as a good heat stabilizer, since the ions are bound to form crystals due to a strong ionic binding force, the compound cannot serve as a flame retardant or heat stabilizer.

Therefore, in the present disclosure, the structure of metal phosphate compounds, which are widely distributed in the natural world and are economical materials with good compatibility, is changed, and the structure-changed metal phosphate compound is used to inhibit the crystal formation to reduce the particle size. Due to the reduced particle size, most of the phosphate ions in the inorganic compound can absorb HCl, thereby effectively preventing discoloration of polymers such as PVC, and the dispersibility thereof in the polymer is improved. Therefore, the heat stabilizer has improved performance.

Therefore, in the present disclosure, as one method of suppressing the crystallinity of metal phosphate compounds, as a polyvalent cation denoted by A, a single type of cation or a mixture of two or more types of cations selected from the group consisting of Al, Fe, Ti, Sn, Ba, Zn, Cu, Cd, Pb, Mn, Ni, Sr, and Mo are used to improve thermal stability.

That is, instead of Ca (cation) that is conventionally used, a single type of metal cation selected from the above-mentioned group is used alone, or two or more types of metal cations are sued in a manner that a portion of metal cations including Ca are replaced with one or more types of other metal cations. When the replaced metal cations are used, the content of a substitute cation is controlled within an appropriate range.

In a preferred embodiment of the present disclosure, in the case where, as the polyvalent cation represented by A in the formula, a form in which a portion of one type of metal cation including Ca is replaced with at least one type of other metal cation is used, the content of the at least one type of other metal cation as a substitute is 50 mol % or less with respect to the total mole number of A.

In the chemical formula above, w is a coefficient of the molecular formula of A and preferably satisfies the range of 2 to 5 to maintain electrical neutrality with respect to the phosphate. In addition, in the preferred embodiment of the present disclosure, w, x, y, and z satisfy an expression of 2w=3x+2y+1z when X is a monovalent anion but satisfy an expression of 2w=3x+2y+0.5z when X is a divalent anion.

In addition, in the present disclosure, the thermal stability is improved by suppressing the crystallinity of the metal phosphate compound by changing the type or content ratio of the anion represented by X in the above chemical formula.

Specifically, in the above chemical formula, X is at least one type of anion selected from the group consisting of Cl⁻, Br⁻, NO₃⁻, OH⁻, acetate, cyanide, thiocyanate, isocyanate, hydrogensulfate, dihydrogen phosphate, phosphite, polyphosphate, carbonate, sulfonate, borate, carbonate, sulfate, carboxylate, adipate, dodecylsulfate, nitrate, and P₂O₇⁴⁻.

When X is a carboxylate, at least one selected from the group consisting of stearates, hexadecanoates, tetradecanoates, laurates, octanoates, octoates, and acetates may be used.

The thermal stability may be improved in a manner that the anion represented by X is used alone, or that two or more types of anions are introduced, or the existing OH⁻ ion of hydroxyapatite is replaced with another type of anion.

Specifically, a heat stabilizer compound as an end product can be prepared by using a metal salt starting material including a phosphoric acid (salt) and an anion other than OH⁻ ions that maintain charge balance with metal cations, or by adding an excessive amount of ions that form ionic bonds in the form of sodium salts to exchange OH⁻ ions with other types of ions.

In addition, according to one embodiment of the present disclosure, the thermal stability can be improved by lowering the crystallinity of the metal phosphate by ion-exchanging OH⁻ ions among the anions represented by X with one or more types of anions selected from the group consisting of Cl⁻, Br⁻, NO₃⁻, acetate, cyanide, thiocyanate, isocyanate, hydrogensulfate, dihydrogen phosphate, phosphite, polyphosphate, carbonate, sulfonate, borate, carbonate, sulfate, carboxylate, adipate, dodecylsulfate, nitrate, and P₂O₇⁴⁻, in a ratio of 0.1 to 100 mol %.

Among various anions, organic anions such as stearate having a formula weight greater than that of the OH ion are preferably used, but the anions to be used are not limited thereto.

Among the anions, stearate showed the best thermal stability of about 3300, and octanoate showed a good thermal stability of about 2300. Even in the case of using other anions such as adipates, Br⁻, OH⁻, Cl⁻, phosphate, thiocyanate, dodecyl sulfate, sulfate, acetate, carbonate, EDTA, hydrogen sulfate, nitrate, and cyanide, a relatively good thermal stability, as high as about 700 or more, was exhibited.

In addition, in the above chemical formula, z is the content ratio of anions and is most preferably in the range of 0 to 3.

In the above chemical formula, x and y are each independently a number within the range of 0 to 5, in which there is no case that both of x and y are 0 at the same time, and either one of x and y is not 0. That is, either phosphate ions (PO₄³⁻) or hydrogen phosphate ions (HPO₄²⁻) must be included in the above chemical formula.

In addition, in the above chemical formula, n is within the range of 0 to 12, and water may be or may not be included.

The heat stabilizer represented by the above chemical formula according to the present disclosure preferably further includes various types of dispersants capable of serving as ligands for the polyvalent cation A in the above chemical formula.

Specifically, as the dispersant, one or more materials selected from the following may be used: one or more diesters selected from the group consisting of amines, amides, phosphonates, carboxylic acids, thioesters, alkanoates, diketones, ketoesters, oxalates, malonates, succinates, glutarates, and adipates;
ketoacids having one carboxylic acid and one ester group;
lactones including maleic anhydride, succinic anhydride, and lactide;
lactams including caprolactam;
a chelating agent including a polyvalent acid or a salt thereof;
vinyl ester derivatives including vinyl acetate;
poly(ethylenimine) and derivatives thereof;
(meth)acrylates and derivatives thereof;
cellulose derivatives; and
cellulose acetate derivatives.
The dispersant according to the present disclosure may perform the following roles:
first, since the dispersant has at least one carbonyl group, the dispersant provides electron pairs by an ionic bond, a coordinated covalent bond, or a strong ion-dipole interaction with a divalent or higher metal ion;
second, the dispersant increases an ionic distance between the metal cation A and the anion X to reduce an ionic binding force;
third, the dispersant suppresses crystal formation of the ionic compound and thus reduces the size of solid particles, thereby increasing the particle surface area; and
fourth, the dispersant help phosphate ions more quickly and easily absorb HCl generated by thermal decomposition, thereby facilitating the formation of phosphate glass on the surface.

The dispersant according to the present disclosure preferably contains the ligand at a ratio of 1:0.5 to 1:6 with respect to the polyvalent cation A in order to achieve the above-described effects.

In addition, the addition of various dispersants increases miscibility with polymers such as PMMA, PS, PB, PC, PE, PP, ABS, natural rubber, synthetic rubber, etc. as well with PVC.

The method of preparing the polymer processing heat stabilizer represented by Chemical Formula 1 according to the present disclosure includes: a first step of preparing a mixed solution by mixing an aqueous metal salt solution and an aqueous phosphoric acid (salt) solution containing metal cations, a second step of adjusting pH by adding a basic solution to the mixed solution, a third step of stirring the pH-adjusted mixed solution for 10 to 120 minutes to control the size of generated particles, and a step of inducting precipitation in the mixed solution to generate metal phosphate particles.

The first step is a step of preparing an aqueous solution by dissolving a metal salt and phosphoric acid (salt) containing a metal cation in water. Here, a heat stabilizer compound as an end product can be prepared by: changing the structure by substituting cations in the aqueous metal salt solution with various metal cations; using a metal salt starting material including a phosphoric acid (salt) and an anion other than OH⁻ ions to maintain charge balance with metal cations; or adding an excessive amount of ions that form ionic bonds in the form of sodium salts to exchange OH⁻ ions with other types of ions.

The phosphoric acid (salt) containing metal cations is preferably reacted with the metal salt at a molar concentration of 0.5:1 to 0.8:1 in terms of reducing the particle size and forming a heat stabilizer having a neutral pH.

The second step is a process of adjusting the pH by adding a basic solution to the mixed solution. The basic solution used in this step is at least one selected form the group consisting of NH₄OH, LiOH, NaOH, and KOH.

In the second step, the pH can be adjusted to the range of 7 to 13. It is more preferable to adjust the pH to around 10 to 13 using a strong base to improve thermal stability by reducing crystallinity and making the particle size small.

The pH-adjusted mixed solution may undergo the third step in which the pH-adjusted mixed solution is stirred for 10 to 120 minutes to complete the reaction, and the size of generated particles is adjusted. The sizes of particles formed through the third step of stirring may be non-uniform and in the range of 0.5 to 150 nm.

The metal phosphate according to the present disclosure exhibits better thermal stability as the particle size is smaller. However, it was confirmed that the metal phosphate with the particle size in the above-mentioned range exhibited a superior thermal stability of 700 seconds or longer compared to calcium stearate.

Finally, the mixed solution undergoes a precipitation reaction so that the metal phosphate particles can be obtained.

When processing a polymer selected from the group consisting of PVC, PMMA, PS, PB, PC, PE, PP, ABS, natural rubber, and synthetic rubber, the prepared polymer processing heat stabilizer of the present disclosure is added in an amount of 1 to 5 parts with respect to the weight of the polymer, thereby improving the thermal stability of the polymer. That is, since the metal phosphate compound represented by Chemical Formula 1 according to the present disclosure exhibits excellent thermal stability, with the use of even a small amount, it can exhibit three times higher heat stabilization effects than existing heat stabilizers, thereby preventing discoloration of the polymer to which the heat stabilizer is added.

### MODE FOR INVENTION

Hereinafter, preferred embodiments of the present disclosure will be described in detail. The following examples are only for illustrative purposes, and the scope of the present disclosure should not be construed as being limited by the examples. In addition, in the following examples, specific compounds were used, but it is obvious to those skilled in the art that their equivalents can be used instead of the compounds to obtain equal or similar degrees of effects.

### Examples 1 to 4: Preparation of Metal Phosphate (Ca₅(PO₄)₃OH) Having Various Particle Sizes

0.1 mole of CaCl₂ was dispersed in 1 L of water, 0.06 mole of K₃PO₄ which was preliminarily prepared was added to the calcium chloride aqueous solution, and metal phosphate particles with different sizes were prepared by varying the type of basic solution, pH, and stirring time as shown in Table 1 below. Different basic solutions according to Examples 1 to 4 were added to adjust the pH to the range of 7 to 13, and then the mixed solutions were stirred for 10 to 120 minutes to adjust the particle size, followed by filtering with filter paper, washing with distilled water, and drying.

TABLE 1

| | | | Stirring time | Particle size |
|---|---|---|---|---|
| | Basic solution | Final pH | (minutes) | (nm) |
| Example 1 | NH₄OH | 7 | 300 | 150 |
| Example 2 | LiOH | 9 | 200 | 45 |
| Example 3 | NaOH | 13 | 10 | 30 |
| Example 4 | KOH | 13.5 | 10 | 2 |

### Experimental Example 1: Confirmation of Thermal Stabilization Effect According to Particle Size

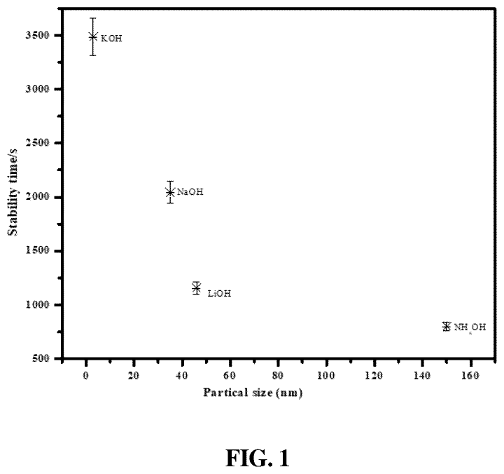

The particles prepared according to Examples 1 to 4 were subjected to SEM-based particle size analysis, and the results revealed that the particles have sizes in the range of 0.5 to 150 nm as shown in Table 1. In addition, in order to see the thermal stabilization effect according to the particle sizes, 1 phr of each heat stabilizer was added to PVC, the color change was examined using a test paper of Congo red. The results are shown in FIG. 1 below.

Referring to FIG. 1, it can be seen that the particle size is different depending on the type and pH of the basic solution used and the stirring time. The smaller the particle size, the larger the surface area, the lower the crystallinity, and the better the thermal stability.

### Examples 5 to 11: Preparation of Metal Phosphate According to Changes in the Content Ratio of Metal Cations to the Concentration of Phosphorus in Phosphate

The concentration of 85% H₃PO₄ in 1 L of water was fixed to 0.1 mole, various metal ions (Example 5: Ca, Example 6: Ba, Example 7: Sr, Example 8: Cd, Example 9: Fe, Example 10: Zn, and Example 11: Sn) were used for metal salts represented by M(NO₃)₂, and the concentrations thereof were changed within the range of 0.05 to 0.08 mole with respect to 0.1 mole of H₃PO₄.

Then, the equivalent ratio of NaOH was instantly added to adjust the pH to 13.5, and the mixture was stirred for 30 minutes while slowly increasing the temperature to 85° C. to produce metal phosphate particles having a particle size of about 25 nm. After filtering with filter paper, the particles were washed with distilled water and dried.

### Experimental Example 2: Confirmation of Thermal Stabilization Effect of Metal Phosphate Prepared According to Changes in Content Ratio of Metal Cations

To see the thermal stabilization effect according to the type of metal ion in each of the metal phosphate salts prepared in Examples 5 to 11, particle size, 1 phr of each metal phosphate salt was added to PVC, the color change was examined using a test paper of Congo red. The results are shown in FIG. 1 below.

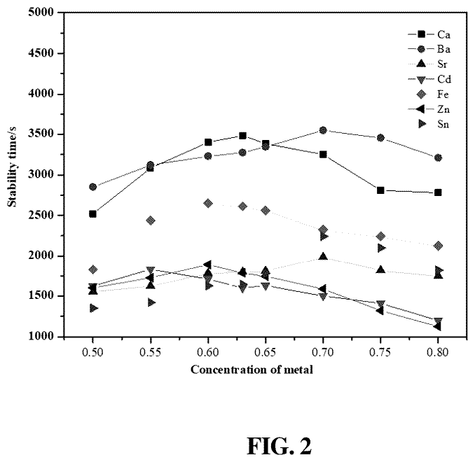

Next, referring to FIG. 2, although there was some difference depending on the type of metal cation, it was confirmed that in all of the examples, a thermal stability of 1000 seconds or more was exhibited. In particular, it can be seen that B a, Ca, and Fe have relatively excellent thermal stability.

In addition, regarding the concentration of a metal cation with respect to phosphorus, in the case of Ca, Fe, Zn, and Cd, the thermal stability gradually increased up to 0.65 mole, and then slightly decreased thereafter.

On the other hand, in the case of Ba, Sr, and Sn, it can be confirmed that the thermal stability gradually increases until the concentration reaches 0.65 mole, and the best thermal stability is exhibited at 0.7 mole.

### Example 12: Preparation of Metal Phosphates Using Metal Salts Having Various Combinations of Metal Cations

When the concentration of H₃PO₄ was fixed to 0.6 moles relative to the metal cation, and the basic metal salt was represented by M(NO₃)₂, metal phosphate salts were prepared while replacing a portion of Ca ions as M with other metal ions, in which the amount of replaced Ca ions was changed at an interval of 10%. Ba, Cd, Zn, Sn, Al, Ti, and Mo ions were used as metal ions to replace Ca ions. After mixing the phosphate and a metal salt, the pH was fixed to 13 using NaOH, and rapid synthesis was performed. After stirring for 10 minutes, washing and drying were performed in the same manner to produce each metal phosphate.

### Experimental Examples 3: Confirmation of Thermal Stabilization Effect of Metal Phosphates Using Metal Salts Having Various Combinations of Metal Cations

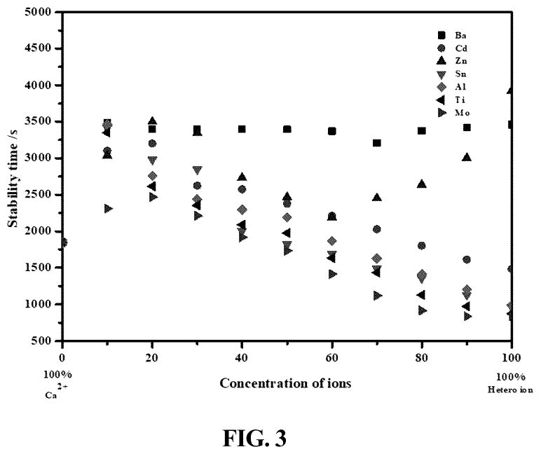

To see the thermal stabilization effect according to different combinations of metal cations in each of the metal phosphate salts prepared in Examples 12, 1 phr of the metal phosphate salt was added to PVC, the color change was examined using a test paper of Congo red. The results are shown in FIG. 3 below.

Next, referring to FIG. 3, in the case of Ba, it was found that a thermal stability of about 3500 is maintained regardless of the concentration of Ba replacing Ca. In the case of Ti, the thermal stability decreased slightly until the molar ratio of Ti:Ca reached 50:50 mol %, and then the thermal stability increased after the molar ratio of Ti was 50 mol % or more.

In addition, in the case of Zn, it was shown that when Ca was not present at all (100 mol % of Zn), the crystallinity was suppressed at the highest level and the solubility in PVC was increased, so that thermal stability was improved. In addition, in the case of Cd, Sn, Al, and Mo metal ions, the thermal stability decreased as the content of metal ions replacing Ca ions increased.

### Example 13: Preparation of Metal Phosphates According to Types of Anions

0.1 mole of Ba(NO₃)₂ was first dispersed in 1 L of water, the ratio of 85% H₃PO₄ for metal ions was fixed to 0.6, and 0.19 mole of NaOH was instantaneously added for pH adjustment. Then, stearate, octanoate, adipate, Br⁻, OH⁻, Cl⁻, phosphate, thiocyanate, dodecylsulfate, sulfate, acetate, carbonate, EDTA, hydrogen sulfate, nitrate, or cyanide were introduced, in a molar ratio of 0.2 to Ba ions in the form of Na— salt, into a boiling solution to synthesize an ionic compound. After a solid precipitate was formed, an Na anion salt was added in a molar ratio of 5 with respect to Ba ions, and an anion exchange reaction was performed for an additional hour. After stirring, the mixture was filtered with filter paper, and the resulting precipitate was washed with distilled water and dried to prepare a metal phosphate.

### Experimental Example 4: Confirmation of Thermal Stabilization Effect of Metal Phosphates Prepared Using Different Types of Anions

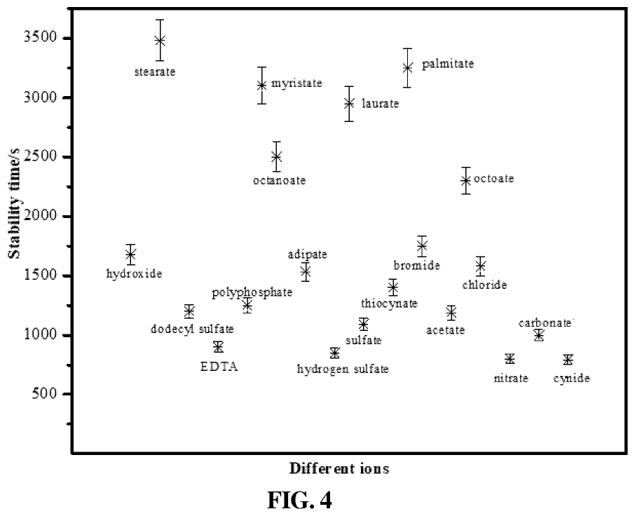

To see the thermal stabilization effect according to the use of different types of anions for each of the metal phosphate salts prepared in Examples 13.1 phr of the metal phosphate salt was added to PVC, the color change was examined using a test paper of Congo red. The results are shown in FIG. 4 below.

Referring to FIG. 4, stearate showed the best thermal stability of about 3300, and octanoate showed a good thermal stability of about 2300. Even in the case of using other types of anions such as adipates, Br⁻, OH⁻, Cl⁻, phosphate, thiocyanate, dodecyl sulfate, sulfate, acetate, carbonate, EDTA, hydrogen sulfate, nitrate, and cyanide, a relatively good thermal stability, as high as about 700 or more, was exhibited.

### Example 14: Preparation of Metal Phosphates According to Types of Dispersants

0.1 mole of a metal nitrate in which Ca(NO₃)₂, Ba(NO₃)₂, and Zn(NO₃)₂ were mixed in a ratio 8:1:1 was dissolved in 0.5 L of water. Apart from this, tetraethylene pentamine (TEPA), 2,4-pentanedione, diethyl malonate (DEM), poly(vinyl acetate) (PVAc), poly(ethyl acrylate) (PEA), poly(ethylene imine) (PEI), carboxymethyl cellulose (CMC), uracil, caprolactone, caprolactam, adipic acid, and methyl acrylate were each dissolved in 0.5 L of acetone in advance, and then each of the dispersants was added in an amount that the ligand in the dispersant is in a molar ratio of 1:2 with respect to the metal ions to form a complex with the metal ions. Next, 0.06 mole of (NH₄)₂HPO₄ was dissolved in 0.1 L of water and immediately added to the mixed solution. To adjust the pH to 13, a 2M KOH solution was added dropwise and vigorously stirred at room temperature for 1 hour. Thereafter, the mixture was filtered with filter paper, and the particles were washed with distilled water and dried in an oven.

### Experimental Example 5: Thermal Stability Test of Metal Phosphate According to Types of Dispersants

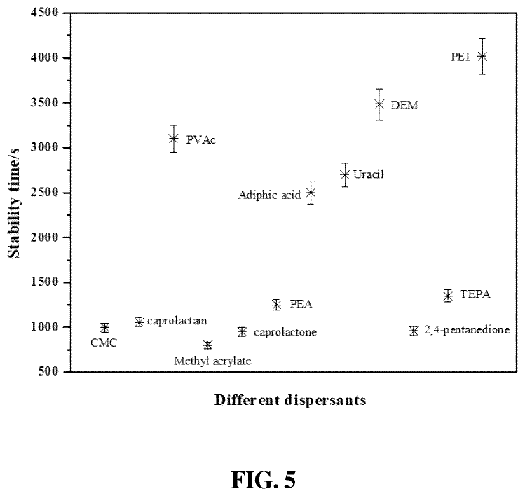

To see the thermal stabilization effect of each of the prepared metal phosphates according to the use of different dispersants in Example 14, 1 phr of each prepared metal phosphate was added to PVC, the color change was examined using a test paper of Congo red. The results are shown in FIG. 5 below.

Referring to FIG. 5, the thermal stability of metal phosphates using dispersants such as polyethyleneimine (PEI), diethyl malonate (DEM), polyvinyl acetate (PAVc), adipic acid, and uracil was as high as 2500 or more, and the thermal stability of metal phosphates using other dispersants such as tetraethylenepentamine (TEPA), poly(ethyl acrylate (PEA), carboxymethyl cellulose (CMC), caprolactam, caprolactone, 2,4-pentanedione, and methyl acrylate had a relativity good value of 700 or more.

### Example 15: Preparation of Hydroxyapatite According to Types of Dispersants

0.1 mole of Ca(NO₃)₂ was dissolved in 0.5 L of water, and then each dispersant such as 2,4-pentanedione, diethyl malonate (DEM), poly(vinyl acetate) (PVAc), poly(ethylene imine) (PEI) preliminarily dissolved in 0.5 L of acetone were mixed such that the carbonyl group serving as the ligand is in a ratio of 1:2 with respect to calcium ions. Thus, a complex with metal anions was prepared. Then, 0.06 mole of phosphoric acid was diluted in 0.1 L of water and immediately added to the mixed solution. To adjust the pH to 13, a 2M KOH solution was added dropwise and vigorously stirred for 1 hour. Thereafter, the mixture was filtered with filter paper, and the particles were washed with distilled water and dried in an oven.

### Experimental Example 6: Comparison in Film Discoloration Process According to Types of Dispersants

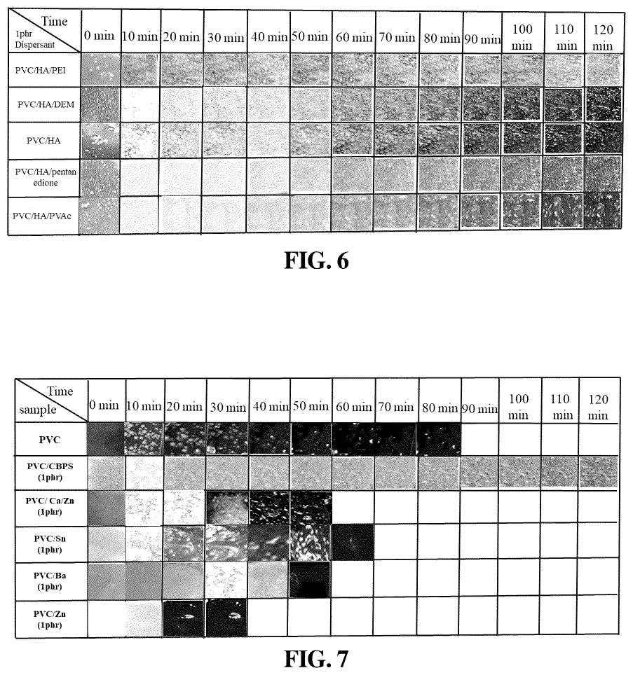

In Example 15, 1 phr of each of the dried hydroxyapatite samples prepared using various dispersants was added to 3 g of PVC and dispersed in THE to prepare a film. The discoloration process of each film was observed in an oven at 180° C. at time intervals of 10 minutes. The results are shown in FIG. 6.

Referring to FIG. 6, the thermal stability of the prepared films was better in order of PEI, 2,4-pentanedione, and PVAc. In the case of diethyl malonate (DEM), it exhibited similar characteristics to PVA/hydroapatite (HA) containing no dispersant. From these results, it was confirmed that the thermal stability of PVC was slightly different depending on the type of dispersant.

### Experimental Example 7: Test of Evaluating Thermal Characteristics According to Types of Metal Phosphates

To compare the thermal stability of Ca_{4.5}Ba_{0.5}(PO₄)₂(HPO₄)_{1.5} stearate, Ca/Zn-stearate, Sn-stearate, Ba-stearate, Zn-octoate, etc., which were anions and metal cations confirmed to exhibit relatively excellent thermal stability through a thermal stability test in which the anion and the metal cation were changed, 1 phr of each of them was mixed with 3 g of PVC to make a film, and the color change of the film was observed every 10 minutes. The results are shown in FIG. 7.

Referring to FIG. 7, while the PVC film exhibited significantly reduced thermal stability after about 30 minutes, it was confirmed that PVC/CBPS using Ca and Ba as metal cations and stearate as an anion exhibited excellent thermal stability for 120 minutes.

In addition, it was confirmed that thermal stability can be improved to some extent even when Sn or Ba was used as a metal cation instead of Ca and stearate as an anion.

### Experimental Example 8: Test for Comparing Thermal Characteristics According to Types of Metal Phosphates

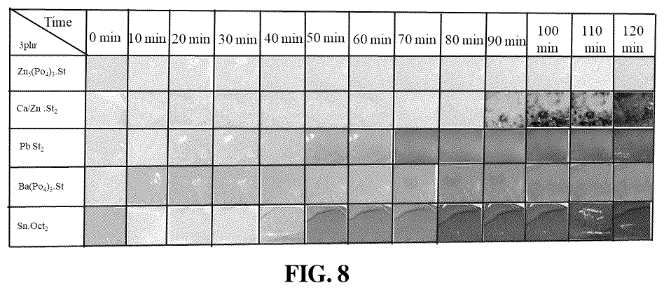

Since the thermal stabilization effect differs depending on the amount of the heat stabilizer used, in this experimental example, the thermal stability was compared by increasing the concentration of the metal salt to 3 phr. First, diethyl adipate, which can act as a ligand for Zn ions, was added in acetone at an equivalent ratio of 1:2 and stirred for 1 hour to form a complex. Next, in order to exchange anions, phosphate and stearate in equivalent ratios were rapidly stirred in the Zn-adipate complex solution to generate a precipitate. After drying in an oven for one day, the precipitate was used in the experiment. The composition used in this experiment included 40 g of dioctyl adipate plasticizer, 3 g of epoxidized soybean oil, 0.5 g of lubricant, Zn₅(PO₄)₃·stearate, and several types of metal salt heat stabilizers, with respect to 100 g of polyvinyl chloride. The mixture was extruded at 180° C. and compressed to 1 mm using a hot press to make a film. After that, the color change over time was observed in an oven at a constant temperature of 180° C. and compared between the films. The results are shown in FIG. 8.

Referring to the results of FIG. 8, it was confirmed that the case of using Zn ions showed superior performance compared to metal salts using lead, barium, or tin ions.

### INDUSTRIAL APPLICABILITY

The heat stabilizer according to the present disclosure has excellent thermal stability, thereby preventing discoloration of polymers such as PVC during processing of the polymers, and is expected to be applicable to various polymers as well as PVC.

1. A heat stabilizer for polymer processing, the heat stabilizer being represented by the following chemical formula:
A_{w}(PO₄)ₓ(HPO₄)_{y}X_{z}·nH₂O
in the chemical formula, A is at least one type of polyvalent cation selected from the group Ca, Mg, Al, Fe, Ti, Sn, Ba, Zn, Cu, Cd, Pb, Mn, Ni, Sr, and Mo;
w satisfies a range of 2 to 5,
X is at least one type of anion selected from the group consisting of Cl⁻, Br⁻, NO₃⁻, OH⁻, acetate, cyanide, thiocyanate, isocyanate, hydrogensulfate, dihydrogen phosphate, phosphite, polyphosphate, carbonate, sulfonate, borate, carbonate, sulfate, carboxylate, adipate, dodecylsulfate, nitrate, and P₂O₇⁴⁻,
z is in a range of 0 to 3,
x and y are each independently a number in the range of 0 to 5,
there is no case that both of x and y are 0 at the same time, either x or y is not 0, and
in the chemical formula, w, x, y, and z satisfy an expression of 2w=3x+2y+1z when X is a monovalent anion but satisfy an expression of 2w=3x+2y+0.5z is satisfied when X is a divalent anion, and n is an integer in the range of 0 to 12.

2. The heat stabilizer of claim 1, wherein as the polyvalent cation represented by A in the chemical formula, one type of metal cation selected from the group as in claim 1 is used solely, or 50 mol % or less of one type of metal cation, including Ca, with respect to a total mole number of the metal cation represented by A is replaced with another type of metal cation.

3. The heat stabilizer of claim 1, wherein X is a form in which 0.1 to 100 mol % of OH-anion is replaced with one or more types of anions selected from the group consisting of Cl⁻, Br⁻, NO₃⁻, acetate, cyanide, thiocyanate, isocyanate, hydrogensulfate, dihydrogen phosphate, phosphite, polyphosphate, carboxylate, carbonate, sulfonate, borate, carbonate, sulfate, carboxylate, adipate, dodecyl sulfate, nitrate, and P₂O₇⁴⁻.

4. The heat stabilizer of claim 1, wherein the heat stabilizer has a particle size in a range of 0.5 to 150 nm.

5. The heat stabilizer of claim 1, further comprising one or more types of dispersants to serve as a ligand for the polyvalent cation contained in the chemical formula, the one or more types of dispersants being selected from:
one or more diesters selected from the group consisting of amines, amides, phosphonates, carboxylic acids, thioesters, alkanoates, diketones, ketoesters, oxalates, malonates, succinates, glutarates, and adipates;
ketoacids having one carboxylic acid and one ester group;
lactones including maleic anhydride, succinic anhydride, and lactide;
lactams including caprolactam;
a chelating agent including a polyvalent acid or a salt thereof;
vinyl ester derivatives including vinyl acetate;
poly(ethylenimine) and derivatives thereof;
(meth)acrylates and derivatives thereof;
cellulose derivatives; and
cellulose acetate derivatives.

6. The heat stabilizer of claim 7, wherein the polyvalent cation A and the ligand included in the dispersant are comprised in a ratio of 1:0.5 to 1:6.

7. A method of preparing the metal phosphate polymer processing heat stabilizer of claim 1, the method being capable of improving thermal stability by reducing a particle of a metal phosphate prepared to a range of 0.5 to 150 nm, the method comprising:
preparing the metal phosphate by rapidly reacting an aqueous metal salt solution and a phosphoric acid (salt) containing a metal cation at a pH of 10 to 13 for 10 to 120 minutes.

8. A method of preparing the metal phosphate polymer processing heat stabilizer of claim 1, the method being capable of improving thermal stability by lowering crystallinity of a metal phosphate, the method comprising:
ion-exchanging OH⁻ anion among the anions represented by X in the chemical formula as in claim 1, with one or more types of anions selected from the group consisting of Cl⁻, Br⁻, NO₃⁻, acetate, cyanide, thiocyanate, isocyanate, hydrogensulfate, dihydrogen phosphate, phosphite, polyphosphate, carboxylate, carbonate, sulfonate, borate, carbonate, sulfate, carboxylate, adipate, dodecyl sulfate, nitrate, and P₂O₇⁴⁻, in a molar ratio of 0.1 to 100 mol %.

9. A method of preparing the metal phosphate polymer processing heat stabilizer of claim 1, the method improving thermal stability by comprising adding one or more types of dispersants to serve as ligands for the polyvalent cation A in the chemical formula of claim 1 so that the dispersants: (a) provide electron pairs by ionic bonding, coordinate covalent bonding, or strong ion-dipole interaction with the polyvalent cation A in the chemical formula of claim 1; (b) increase an ionic distance between the metal cation A and the anion X to reduce an ionic binding force; or (c) suppress crystal formation of the metal phosphate to reduce a particle size, thereby increasing a particle surface area,
the one or more types of dispersants being selected from:
one or more diesters selected from the group consisting of amine, amide, phosphonate, carboxylic acid, thioester, alkanoate, diketones, ketoesters, oxalates, malonates, succinates, glutarates, and adipates;
ketoacids comprising one carboxylic acid and one ester group; lactones, comprising maleic anhydride, succinic anhydride, and lactide;
lactams, comprising caprolactam; chelating agents comprising polyvalent acids or salts thereof;
vinyl ester derivatives, comprising vinyl acetate; poly(ethyleneimine) and derivatives thereof;
(meth)acrylates and derivatives thereof;
cellulose derivatives; and
cellulose acetate derivatives.

10. A polymer composition comprising:
one or more types of polymers selected from the group consisting of PVC, PMMA, PS, PB, PC, PE, PP, ABS, natural rubber, and synthetic rubber; and
the polymer processing heat stabilizer represented by the chemical formula of claim 1.

11. The polymer composition of claim 10, wherein the polymer processing heat stabilizer is comprised in an amount of 1 to 5 parts by weight based on the weight of the polymer.
